(19) United States
(12) Patent Application Publication
(10) Pub. No.: US 2021/0221038 A1
(43) Pub. Date: Jul. 22, 2021

(54) METHOD OF MANUFACTURING MOLDED PRODUCT

(71) Applicant: Kumi Kasei Co., Ltd., Tokyo (JP)

(72) Inventor: Etsuo Okahara, Ube-shi (JP)

(21) Appl. No.: 15/734,344

(22) PCT Filed: Mar. 26, 2019
(86) PCT No.: PCT/JP2019/012923

§ 371 Date: Dec. 2, 2020

(30) Foreign Application Priority Data
Jun. 7, 2018 (JP) 2018-109428

(51) Int. Cl. B29C 45/56; B29C 45/70; B29C 45/73; B29C 45/26

(52) U.S. Cl. CPC B29C 45/561; B29C 45/70; B29C 2045/565; B29C 45/26; B29C 45/73

(57) ABSTRACT

A method of the invention which manufactures a molded product by injection molding using injection molding die including a pair of dies includes: injecting and filling the resin in a molten state in a state where a temperature of the injection molding die is higher than a deformation temperature of resin to be injected and filled; reducing a volume of a cavity due to volume contraction of the resin when cooling thereof; and carrying out molding while maintaining a state where the resin is brought into close contact with both cavity surfaces of the pair of the dies.

### TECHNICAL FIELD

The present invention relates to a method of manufacturing a molded product.

This application claims priority from Japanese Patent Application No. 2018-109428 filed on Jun. 7, 2018, the contents of which are incorporated herein by reference in their entirety.

### BACKGROUND ART

In various fields, a resin molded product obtained by injection molding is used. For example, as an interior part for an automobile or the like, a molded product including a projected portion such as rib, boss, a clip for attachment, or the like which is provided on a non-design surface side (back surface side) of a plate-shaped substrate is widely used. In the molded product including the projected portion, particularly, in the case in which the above-mentioned projected portion is thick, a recess referred to as a sink is easily generated at a portion of the design surface which corresponds to the projected portion of the molded product.

As a method of preventing sink from being generated, for example, a method of setting the temperature of the die located on the design surface side to be higher than the temperature the die located on the non-design surface, causing resin to be brought into close contact with the die located on the design surface and to be separated from the die located on the non-design surface, concentrating sink to the non-design surface of the molded product, and thereby preventing sink from being generated from the design surface is proposed (Patent Documents 1 to 3).

### PRIOR ART DOCUMENTS

### Patent Documents

[Patent Document 1] Japanese Unexamined Patent Application, First Publication No. H6-315961 [Patent Document 2] Japanese Unexamined Patent Application, First Publication No. 2012-192715

[Patent Document 3] Japanese Unexamined Patent Application, First Publication No. 2012-162007

### SUMMARY OF THE INVENTION

### Problems to be Solved by the Invention

However, in the molding method disclosed in Patent Documents 1 to 3, there is a problem in that warpage occurs on the resultant molded product due to difference in temperature of the die. Additionally, since sink is concentrated to the back surface side of the molded product, it is not available to a product having a back surface serving as a design surface of the molded product or a transparent product having a back surface which is visible from a top surface side. Furthermore, since the non-design surface side of resin is separated from the die when cooling thereof and therefore heat transfer from the resin to the die is hindered, there is a problem in that a length of cooling time becomes longer, and the productivity thereof is degraded.

Moreover, when an amount of resin to be filled to the inside of a cavity is large, a time of contact between the resin and the die that is located on the non-design surface side and has a low temperature becomes longer, a skin layer develops due to progress of cooling of the non-design surface side, the design surface side is thereby deformable easier than the non-design surface, and sometimes sink is generated on the design surface. In contrast, when the filling amount of resin is small, gas remains near the final-filled portion of the resin, and therefore a linear defect which is thought as a boundary between the portion in close contact with the die and the portion separated therefrom may be generated on the design surface. Adjustment of the filling amount of resin while obtaining a balance so as not to occur above-described defect is more difficult for a die for molding a plurality of products.

The invention has an object to provide a method of manufacturing a molded product, which can prevent sink from being generated not only on a top surface but also on a back surface and can manufacture a molded product having an excellent appearance with a high degree of productivity.

### Means for Solving the Problems

An aspect of the invention includes the following configuration.

(1) A method of manufacturing a molded product by injection molding using injection molding die including a pair of dies includes: injecting and filling the resin in a molten state in a state where a temperature of the injection molding die is higher than a deformation temperature of resin to be injected and filled; reducing a volume of a cavity due to volume contraction of the resin when cooling thereof; and carrying out molding while maintaining a state where the resin is brought into close contact with both cavity surfaces of the pair of the dies.

(2) In the method of manufacturing a molded product according to (1), temperatures of the pair of the dies are the same as each other.

(3) In the method of manufacturing a molded product according to (1) or (2), the injection molding die has a parting line having a pinched-off structure.

### Effects of the Invention

According to the aspect of the invention, it is possible to provide a method of manufacturing a molded product, which can prevent sink from being generated not only on a top surface but also on a back surface and can manufacture a molded product having an excellent appearance with a high degree of productivity.

### BRIEF DESCRIPTION OF THE DRAWINGS

FIG. 1 is a cross-sectional view showing an example of an injection molding die used for a method of manufacturing a molded product according to an embodiment of the invention.

FIG. 2 is a cross-sectional view showing a state where the injection molding die shown in FIG. 1 is completely mold-clamped.

FIG. 3 is a cross-sectional view showing a state when injecting and filling of resin is carried out in the injection molding using injection molding die shown in FIG. 1.

FIG. 4 is in a cross-sectional view showing a state when cooling is carried out in the injection molding using injection molding die shown in FIG. 1.

FIG. 5 is a picture showing a back surface side of a molded product obtained by Example 1.

FIG. 6 is an enlarged picture showing part of a rib near the back surface of the molded product obtained by Example 1.

FIG. 7 is a picture showing a back surface side of a molded product obtained by Comparative example 1.

FIG. 8 is a picture showing a back surface side of a molded product obtained by Comparative example 3.

### EMBODIMENTS FOR CARRYING OUT THE INVENTION

A method of manufacturing a molded product according to the embodiment of the invention is a method of manufacturing a molded product by injection molding using injection molding die including a pair of dies.

In the method of manufacturing a molded product according to the embodiment of the invention, injecting and filling of the resin in a molten state is carried out in a state where a temperature of the injection molding die is higher than a deformation temperature of resin to be injected and filled, a volume of a cavity is reduced due to volume contraction of the resin when cooling thereof; and molding is carried out while maintaining a state where the resin is brought into close contact with both cavity surfaces of the pair of the dies.

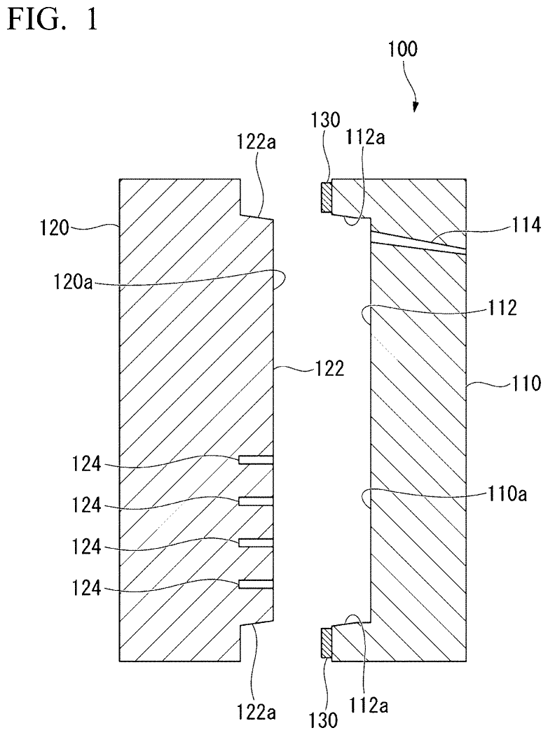

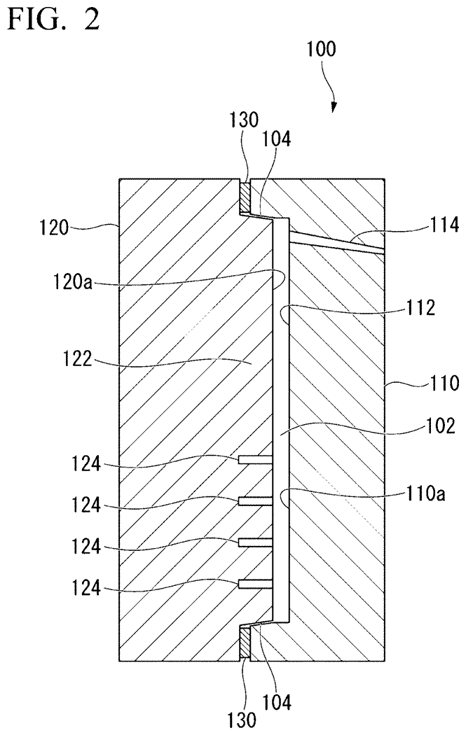

Hereinafter, as an example of the method of manufacturing a molded product according to the embodiment of the invention, a method of manufacturing a molded product by use of an injection molding die 100 (hereinbelow, also referred to as “die 100”) shown in FIGS. 1 and 2 as an example will be described. Note that, dimensions or the like of the drawings described in the following explanation are used as an example, and the invention is not necessarily limited thereto but can be carried out while being appropriately modulated without departing from the scope thereof.

As shown in FIGS. 1 and 2, the die 100 includes a cavity die 110 and a core die 120 which form a pair. The die 100 is an injection molding die that is used to manufacture a molded product having a plurality of ribs provided parallel to each other on a back surface of a plate-shaped substrate. In the die 100, the cavity die 110 is a fixed die and the core die 120 is a movable die.

A recess 112 having a complementary shape with respect to a shape of a substrate portion of the molded product is formed near the core die 120 of the cavity die 110. Furthermore, a resin flow path 114 that is communicated with the recess 112 is formed in the cavity die 110.

A projected portion 122 is provided near the cavity die 110 of the core die 120, and a plurality of recess grooves 124 each having a complementary shape with respect to a shape of the rib of the molded product are formed on a surface of the projected portion 122 near the cavity die 110. Moreover, an ejector pin that is not shown in the drawings and is used to push and demold the molded product after injection molding is provided in the core die 120.

As shown in FIG. 2, in the die 100, the core die 120 is close to the cavity die 110, mold clamping is carried out in a state where a die-thickness adjustment machine 130 is held between the cavity die 110 and the core die 120, and therefore a cavity 102 is formed thereinside. Injecting and filling of resin in a molten state from an injection apparatus to the inside of the cavity 102 through the resin flow path 114 is carried out.

By adjusting the thickness of the die-thickness adjustment machine 130, it is possible to adjust a plate thickness of the resultant molded product.

The die 100 is a die having a so-called shear edge structure in which a parting line (PL) 104 between the cavity die 110 and the core die 120 is a pinched-off structure. Specifically, the PL 104 of the die 100 includes a portion that is formed of a sidewall surface 112a of the recess 112 of the cavity die 110 and a sidewall surface 122a of the projected portion 122 of the core die 120 and is substantially parallel to a movable direction of the cavity die 110.

In the die 100 having the above-described PL 104 formed of the pinched-off structure, it is possible to increase or decrease the volume of the cavity 102 while preventing resin from leaking out by causing the cavity die 110 to move close to or separately from the core die 120 in a state where the sidewall surface 112a of the recess 112 of the cavity die 110 and the sidewall surface 122a of the projected portion 122 of the core die 120 face each other.

As a method of manufacturing a molded product by use of an injection molding machine including the die 100, for example, a method including an injecting/filling step, a cooling step, and a demolding step which are described below is adopted.

Injecting/filling step: Step of injecting and filling resin in a molten state to the inside of the cavity 102 of the die 100 in which the cavity die 110 and the core die 120 are mold clamped in a state where the temperature of the die 100 is higher than the deformation temperature of resin to be injected and filled.

Cooling step: Step of cooling the resin while reducing the volume of the cavity 102 along with volume contraction of the resin due to cooling.

Demolding step: Step of opening the die 100 and demolding the molded product after molding.

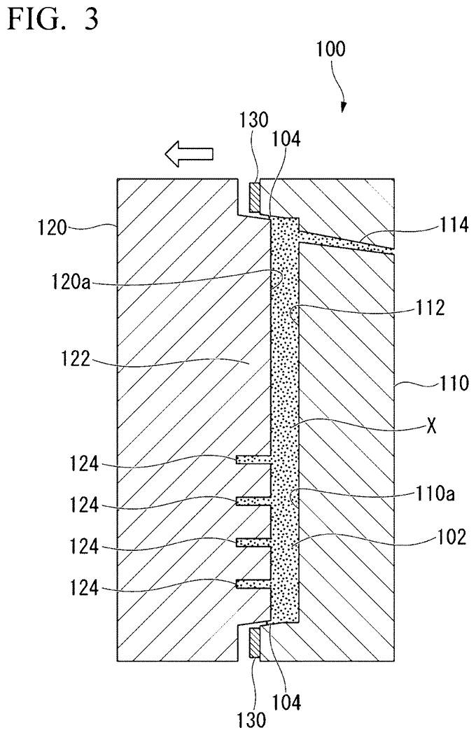

As shown in FIG. 3, in the injecting/filling step, the resin X in a molten state is injected and filled to the inside of the cavity 102 in a state where the temperature of the die 100 is higher than the deformation temperature of the resin X to be injected and filled.

Consequently, in the injecting/filling step, since it is possible to cause the resin X to be in a state of being in close contact with both the cavity surface 110a of the cavity die 110 and the cavity surface 120a of the core die 120, it is possible to prevent sink from being generated in the resultant molded product.

Note that, the deformation temperature of the resin is a value measured under the condition in which a bending load of 1.80 MPa is applied thereto by the method in compliance with JIS K7191-2.

In the injecting/filling step, it is preferable that the difference in temperature between the die 100 and the deformation temperature of the resin X be 5 to 30° C. In the case in which the resin X includes a first component (a resin component having the largest amount thereof) and a second component (a resin component other than the first component), a range of the value of the deformation temperature varies depending on the deformation temperature of the second component and the proportion of the second component. The larger the proportion of the second component having a low deformation temperature, the lower the deformation temperature becomes. As long as the difference in temperature is greater than or equal to the lower limit of the above range (5 to 30° C.), it is easy for the resin to be in a state of being in close contact with the cavity surface in the injecting/filling step, and sink is easily prevented from being generated on the molded product. As long as the difference in temperature is less than or equal to the upper limit of the above range, deformation is less likely to occur when removing of the molded product.

Although the temperatures of the cavity die 110 and the core die 120 when injecting and filling of resin may be the same as or different from each other, it is preferable that the temperatures be the same as each other in the point of ease of prevention of the molded product from being warped. Moreover, when temperatures of the cavity die 110 and the core die 120 are the same as each other, the adhesion force between the resin X and the cavity die 110 is equal to the adhesion force between the resin X and the core die 120. Accordingly, it is easy to cause the resin X to be in a state of being in close contact with both the cavity surface 110a of the cavity die 110 and the cavity surface 120a of the core die 120. As a result, it is easy to obtain a molded product not having sink on both the top surface and the back surface.

In the injecting/filling step, it is preferable that, when the resin pressure at the time of injecting and filling of the resin X exceeds a predetermined pressure by adjusting the mold clamping force of the die 100 and the filling amount of the resin X, the core die 120 retract from the cavity die 110 by the resin pressure, and therefore the volume of the cavity 102 increases. For this reason, also in the cooling step, the volume of the cavity can be easily reduced due to volume contraction of the resin by cooling thereof.

Regarding the mold clamping force of the die 100, an average inside pressure of the die when completion of cooling is preferably 2 to 30 MPa, is more preferably 3 to 20 MPa, and is further more preferably 5 to 10 MPa. As long as the mold clamping force is greater than or equal to the lower limit of the above range (2 to 30 MPa), non-complete filling of the injected and filled resin at the die end portion is easily prevented from occurring. In addition, in the cooling step, it is easy to cause the core die to be close to the cavity die due to the volume contraction of the resin and therefore reduce the volume of the cavity. As long as the mold clamping force is less than or equal to the upper limit of the above range, it is easy to cause the core die to retract by the pressure of the injected and filled resin and increase the volume of the cavity.

In other cases, the core die 120 is retracted in advance from a state of being completely mold clamped, and the injecting and filling of the resin X may be carried out in a state where the volume of the cavity is larger than that of the case of being completely mold clamped.

As mentioned above, in the molding using the die 100, in the injecting/filling step, the inside of the cavity 102 is filled with the resin X having the amount exceeding the volume of the cavity when the die 100 is completely mold clamped, and the volume of the cavity is larger than the volume of the cavity when the die is completely mold clamped. Additionally, regarding the filling amount of the resin at this time, it is preferable that, the volume of the molded product after volume contraction due to cooling is the same as the volume of the cavity when the die 100 is completely mold clamped or is an amount larger than the volume of the cavity. Consequently, in the cooling step, it is easy to reduce the volume of the cavity due to volume contraction of the resin X and maintain a state where the resin X is in close contact with both the cavity surface 110a of the cavity die 10 and the cavity surface 120a of the core die 120.

A resin used for molding is not particularly limited, for example, polyolefin resin, polystyrene resin, acrylonitrile butadiene styrene (ABS) resin, acrylonitrile-ethylene propylene rubber-styrene (AES) resin, polymethyl methacrylate (PMMA) resin, polycarbonate resin, polyamide resin, or the like is adopted therefor. The resin for use may be one type or may be two or more types of composite.

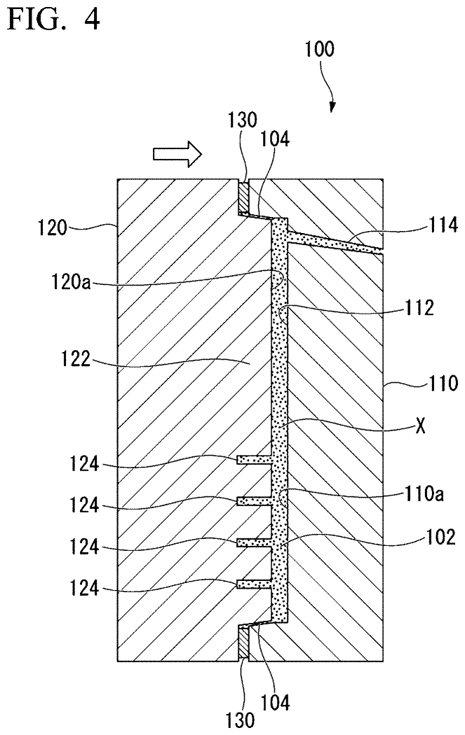

As shown in FIG. 4, in cooling step, while cooling the resin X, the core die 120 is close to the cavity die 110 due to the volume contraction of the resin X by cooling, and therefore the volume of the cavity 102 is reduced. In this example of the cooling step, since the core die 120 approaches the cavity die 110 due to the volume contraction of the resin X by the mold clamping force of the die 100, the volume of the cavity is reduced along with the volume contraction of the resin X. Accordingly, in the cooling step, a state where the resin X is in close contact with both the cavity surface 110a of the cavity die 110 and the cavity surface 120a of the core die 120 is maintained until cooling is completed.

By maintaining the state where the resin X is in close contact with both the cavity surface 110a of the cavity die 110 and the cavity surface 120a of the core die 120 until cooling is completed, sink is prevented from being generated on the molded product. Furthermore, the resin X is separated from the cavity surfaces 110a and 120a, hindering of heat transfer from the resin X to the cavity die 110 or the core die 120 is prevented. Consequently, since the resin X is effectively cooled down, it is possible to cool down the resin for a short period of time.

In the demolding step, the cavity die 110 and the core die 120 are opened, the molded product is pushed out by the ejector pin and is demolded.

As described above, in the embodiment of the invention, injecting and filling of the resin in a molten state is carried out in a state where the temperature of the injection molding die is higher than the deformation temperature of the resin to be injected and filled, and the volume of the cavity due to the volume contraction of the resin is reduced when cooling thereof. As a result, from the time of injecting and filling of resin to completion of cooling, the molding is carried out while maintaining the state where the resin is in close contact with both cavity surfaces of the pair of the dies. As stated above, by preventing the resin from being separated from both cavity surfaces of the pair of the dies during molding, the molded product not having sink on both the top surface and the back surface is obtained. Furthermore, even in the case of a molded product having a projected portion such as a rib or the like, it is possible to prevent sink from being generated. Therefore, the manufacturing method according to the embodiment of the invention is also applicable to manufacture of not only a transparent molded product but also a molded product having a design surface on both a top surface and a back surface.

Moreover, in the embodiment of the invention, unlike a conventional method of separating resin from a non-design surface, gas that is likely to remain at a final filling position inside the cavity of the die can be completely discharged by increasing a resin pressure. Consequently, it is possible to prevent linear defect due to remaining gas from being generated on the molded product.

In addition, in the embodiment of the invention, since it is not necessary to carry out a countermeasure against sink using holding pressure operation after injecting and filling of the resin, the resultant molded product is not affected by a residual stress due to the holding pressure. Furthermore, since the holding pressure operation is not carried out, the pressure inside the die when molding is substantially uniform and an annealing state is substantially obtained. Accordingly, even where the molded product is used for an optical component such as a resin glass, a lens, or the like, it is not necessary to carry out annealing after molding which is essential as a countermeasure against polarization.

Moreover, according to the methods disclosed in Patent Documents 1 to 3 which concentrates sink to the non-design surface side of the molded product by setting difference in temperature between a die located on a design surface side and a die located on a non-design surface side, since resin is separated from the cavity surface and an air thermal insulation layer is thereby formed at the non-design surface side of the molded product, the efficiency of cooling the resin is degraded, and a length of cooling time becomes longer. In contrast, in the embodiment of the invention, since a state where the resin is in close contact with both cavity surfaces of the pair of the dies is maintained during cooling, a length of cooling time can be shorter without lowering the efficiency of cooling the resin, and furthermore it is possible to prevent deformation due to insufficiency of cooling.

Additionally, since it is not necessary to set difference in temperature between the pair of dies, it is possible to sufficiently prevent the molded product from being warped.

Moreover, in the case of using the injection molding die having the PL using a pinched-off structure, control of the resin to be in a state of being in close contact with both cavity surfaces of the pair of the dies during molding can be easily carried out by adjusting the temperature of the die, the mold clamping force, and the filling amount of the resin. In addition, by determining the mold clamping force using the injection molding die having the PL using a pinched-off structure so that the resin pressure inside the die does not excessively increase, the resin is less likely to become an over pack state even at the portion in which a rib or the like is to be formed inside the die.

Note that, the method of manufacturing a molded product according to the embodiment of the invention is not limited to the method of using the injection molding die having the PL using a pinched-off structure. As long as the method of manufacturing a molded product according to the embodiment of the invention can reduce the volume of the cavity due to volume contraction of the resin when cooling thereof, a method of using an injection molding die other than the above-described die 100 may be used.

### EXAMPLES

Hereinbelow, although the invention will be particularly described using Examples, the invention is not limited to the following description.

### Example 1

As an injection molding machine, an electric injection molding machine which includes the injection molding die 1 shown in FIG. 1 as an example and a toggle type mold clamping device and has a maximum mold clamping force of 1800 KN was used. In the toggle type mold clamping device, an amount of resin to be injected is large, and the mold clamping force thereof is larger than a set value when the die thereof opens. Accordingly, when the mold clamping force is higher than the set mold clamping force, it is conceivable that the mold clamping force is applied to the resin in a state where the die opens.

In the injection molding die 1, when the mold clamping is completely carried out, the shape of the cavity is the complementary shape of the product having four kinds of ribs which are provided parallel to each other on a back surface of a plate-shaped substrate, and a projected area including the cavity and a gate portion is approximately 420 cm². The sizes of the plate-shaped substrate and the four kinds of ribs are as follows.
Plate-Shaped Substrate: 200 mm in length×200 mm in width×2 mm in thickness.
Ribs: 30 mm in length and 3 mm in height, the widths of the four kinds of ribs are 1.0 mm, 1.7 mm, 2.4 mm, and 3.1 mm

Twelve ejector pins, each of which has a diameter of 6 mm are provided in the core die, were configured such that entering of air from the outside of the die through the portions at which the ejector pins are provided is possible.

For injection molding, AES resin (produced by Techno Polymer CO., Ltd, 145H, deformation temperature (load of 1.8 MPa): 78° C.) was used. For temperature setting, the barrel temperature was 240° C., and the temperatures of the cavity die and the core die were 95° C. Additionally, the mold clamping force was set to 200 KN. The core die was configured such that: when the resin pressure at the time of injecting and filling of the resin exceeds approximately 5 MPa, the core die is away from the cavity die by the resin pressure and the volume of the cavity increases; and when the core die is close to the cavity die due to volume contraction of the resin in the cooling process, the volume of the cavity decreases. A filling amount of the resin was the amount such that the mass of the resultant molded product is 90 g, and the die was configured not to be completely closed even in a state where cooling is completed. The injection molding was carried out under the above-described conditions, and a molded product was obtained which has: a top surface in a specular surface state; and four kinds of ribs which are different from each other in width are formed on the back surface of the substrate.

During molding, the mold clamping force immediately after filling of the resin reached 300 KN, and in a state where the cavity die is slightly separated from the core die even in the cooling process, the mold clamping force after 30-second cooling was 230 KN and exceeded the set value of 200 KN. For this reason, the volume of the resin after contraction due to cooling exceeds the volume of the cavity when the die is completely mold clamped, it is thought that a state where the resin during molding is in close contact with both the cavity surfaces of the cavity die and the core die is maintained.

The plate thickness of the resultant molded product was approximately 2.1 mm and was slightly thicker than 2.0 mm that is obtained by molding in a state where the die is completely mold clamped.

In the case where the plate thickness of the resultant molded product obtained by this molding method is 2.0 mm, the object can be achieved by adjusting the thickness of the die-thickness adjustment machine 130 in a die-closing state to be 1.9 mm.

### Comparative Example 1

A molded product was obtained in a way similar to the case of Example 1 except that a filling amount of the resin (mass of the molded product) was 86 g and a length of cooling time was 35 seconds.

Although the mold clamping force immediately after filling of the resin was 250 KN, the mold clamping force was lowered to 200 KN after further 15 seconds. For this reason, it is thought that, after 15 seconds from the injecting and filling of resin, the volume of the contracted resin becomes lower than the volume of the cavity when the die is completely mold clamped, and part of the resin is separated from the cavity surface. Moreover, in the case where a length of cooling time is set to 30 seconds, since slight deformation was found from the molded product after removal, a length of cooling time was 35 seconds in order to obtain a non-deformed molded product.

### Comparative Example 2

A filling amount of the resin (mass of the molded product) was 81 g, and a molded product was obtained in a way similar to the case of Example 1 except that a length of cooling time was 40 seconds.

Although the mold clamping force immediately after filling of the resin was 230 KN, the mold clamping force was lowered to 200 KN after further 10 seconds. For this reason, it is thought that, after 10 seconds from the injecting and filling of resin, the volume of the contracted resin becomes lower than the volume of the cavity when the die is completely mold clamped, and part of the resin is separated from the cavity surface. Moreover, in the case where a length of cooling time is set to 35 seconds, since slight deformation was found from the molded product after removal, a length of cooling time was 40 seconds in order to obtain a non-deformed molded product.

### Comparative Example 3

A molded product was obtained in a way similar to the case of Example 1 except that the temperatures of the cavity die and the core die were 60° C.

Although the mold clamping force immediately after filling of the resin was 300 KN, the mold clamping force was 210 KN after further 30 seconds. For this reason, it is thought that the volume of the resin after contraction due to cooling exceeds the volume of the cavity when the die is completely mold clamped.

### Comparative Example 4

A molded product was obtained in a way similar to the case of Example 1 except that: the mold clamping force was 1800 KN; the core die was configured not to move by injecting and filling of the resin; the temperatures of the cavity die and the core die were set to 60° C.; a filling amount of the resin (mass of the molded product) was 80 g; and cooling was carried out after maintaining a holding pressure of 100 MPa for five seconds after injecting and filling.

### Example 2

A molded product was obtained in a way similar to the case of Example 1 except that the resin was changed to PMMA resin (produced by Mitsubishi Chemical Corporation, ACRYPET VH, deformation temperature (load of 1.8 MPa): 100° C.) and molding conditions were changed as shown in Table 1.

During molding, the mold clamping force immediately after filling of the resin reached 300 KN, and in a state where the cavity die is slightly separated from the core die even in the cooling process, the mold clamping force after 30-second cooling was 230 KN and exceeded the set value of 200 KN. For this reason, the volume of the resin after contraction due to cooling exceeds the volume of the cavity when the die is completely mold clamped, it is thought that a state where the resin during molding is in close contact with both the cavity surfaces of the cavity die and the core die is maintained.

### Comparative Example 5

A molded product was obtained in a way similar to the case of Example 2 except that a filling amount of the resin (mass of the molded product) was 98 g and a length of cooling time was 35 seconds.

Although the mold clamping force immediately after filling of the resin was 250 KN, the mold clamping force was lowered to 200 KN after further 20 seconds. For this reason, it is thought that, after 20 seconds from the injecting and filling of resin, the volume of the contracted resin becomes lower than the volume of the cavity when the die is completely mold clamped, and part of the resin is separated from the cavity surface. Moreover, in the case where a length of cooling time is set to 30 seconds, since slight deformation was found from the molded product after removal, a length of cooling time was 35 seconds in order to obtain a non-deformed molded product.

### Comparative Example 6

A filling amount of the resin (mass of the molded product) was 93 g, and a molded product was obtained in a way similar to the case of Example 2 except that a length of cooling time was 40 seconds.

Although the mold clamping force immediately after filling of the resin was 230 KN, the mold clamping force was lowered to 200 KN after further 10 seconds. For this reason, it is thought that, after 10 seconds from the injecting and filling of resin, the volume of the contracted resin becomes lower than the volume of the cavity when the die is completely mold clamped, and part of the resin is separated from the cavity surface. Moreover, in the case where a length of cooling time is set to 35 seconds, since slight deformation was found from the molded product after removal, a length of cooling time was 40 seconds in order to obtain a non-deformed molded product.

### Comparative Example 7

A molded product was obtained in a way similar to the case of Example 2 except that the temperatures of the cavity die and the core die were 80° C.

Although the mold clamping force immediately after filling of the resin was 300 KN, the mold clamping force was 210 KN after further 30 seconds. For this reason, it is thought that the volume of the resin after contraction due to cooling exceeds the volume of the cavity when the die is completely mold clamped.

### Comparative Example 8

molded product was obtained in a way similar to the case of Example 2 except that: the mold clamping force was 1800 KN; the core die was configured not to move by injecting and filling of the resin; the temperatures of the cavity die and the core die were set to 60° C.; a filling amount of the resin (mass of the molded product) was 94 g; and cooling was carried out after maintaining a holding pressure of 100 MPa for five seconds after injecting and filling.

### Example 3

A molded product was obtained in a way similar to the case of Example 1 except that the resin was changed to PMMA resin (produced by Mitsubishi Chemical Corporation, ACRYPET IRK304, deformation temperature (load of 1.8 MPa): 78° C.) and molding conditions were changed as shown in Table 1.

During molding, the mold clamping force immediately after filling of the resin reached 300 KN, and in a state where the cavity die is slightly separated from the core die even in the cooling process, the mold clamping force after 30-second cooling was 230 KN and exceeded the set value of 200 KN. For this reason, the volume of the resin after contraction due to cooling exceeds the volume of the cavity when the die is completely mold clamped, it is thought that a state where the resin during molding is in close contact with both the cavity surfaces of the cavity die and the core die is maintained.

### Comparative Example 9

A molded product was obtained in a way similar to the case of Example 3 except that a filling amount of the resin (mass of the molded product) was 97 g and a length of cooling time was 35 seconds.

Although the mold clamping force immediately after filling of the resin was 250 KN, the mold clamping force was lowered to 200 KN after further 20 seconds. For this reason, it is thought that, after 20 seconds from the injecting and filling of resin, the volume of the contracted resin becomes lower than the volume of the cavity when the die is completely mold clamped, and part of the resin is separated from the cavity surface. Moreover, in the case where a length of cooling time is set to 30 seconds, since slight deformation was found from the molded product after removal, a length of cooling time was 35 seconds in order to obtain a non-deformed molded product.

### Comparative Example 10

A filling amount of the resin (mass of the molded product) was 93 g, and a molded product was obtained in a way similar to the case of Example 3 except that a length of cooling time was 40 seconds.

Although the mold clamping force immediately after filling of the resin was 230 KN, the mold clamping force was lowered to 200 KN after further 10 seconds. For this reason, it is thought that, after 10 seconds from the injecting and filling of resin, the volume of the contracted resin becomes lower than the volume of the cavity when the die is completely mold clamped, and part of the resin is separated from the cavity surface. Moreover, in the case where a length of cooling time is set to 35 seconds, since slight deformation was found from the molded product after removal, a length of cooling time was 40 seconds in order to obtain a non-deformed molded product.

### Comparative Example 11

A molded product was obtained in a way similar to the case of Example 3 except that the temperatures of the cavity die and the core die were 70° C.

Although the mold clamping force immediately after filling of the resin was 300 KN, the mold clamping force was 210 KN after further 30 seconds. For this reason, it is thought that the volume of the resin after contraction due to cooling exceeds the volume of the cavity when the die is completely mold clamped.

### Comparative Example 12

A molded product was obtained in a way similar to the case of Example 3 except that: the mold clamping force was 1800 KN; the core die was configured not to move by injecting and filling of the resin; the temperatures of the cavity die and the core die were set to 70° C.; a filling amount of the resin (mass of the molded product) was 100 g; and cooling was carried out after maintaining a holding pressure of 100 MPa for five seconds after injecting and filling.

### (Evaluation of Sink State)

Sink states on the top surface of the substrate, the upper surface of each rib, and the back surface of the substrate of the molded product obtained by the above various examples were checked, and evaluation was carried out under the following evaluative standards.

◯: sink was not found (Excellence).

Δ: sink was slightly found (Pass).

X: high-visible sink was found (Failure).

### (Evaluation of Deformation)

The presence or absence of warpage of the substrate of the molded product obtained by the above various examples and the presence or absence of deformation which is after removal from the die and is due to insufficient cooling were checked, and evaluation was carried out under the following standards.

◯: warpage or deformation was not found (Excellence).

Δ: warpage or deformation was slightly found (Pass).

X: significant warpage or deformation was found (Failure).

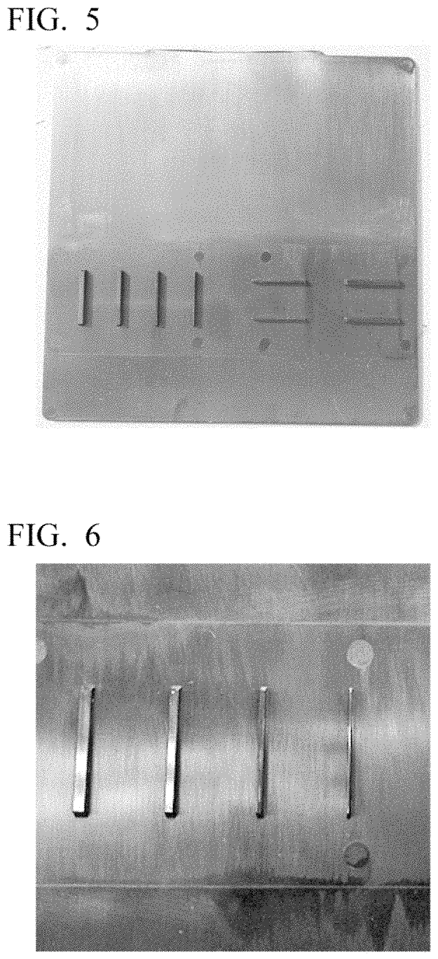

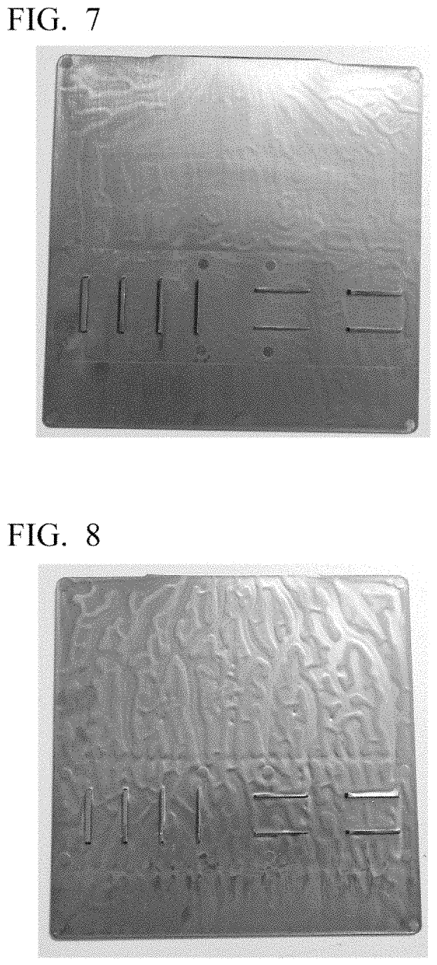

Molding conditions of various examples are shown in Table 1 and the evaluation results are shown in Table 2. A picture showing the back surface side of the molded product obtained by Example 1 is shown in FIGS. 5 and 6. A picture showing the back surface side of the molded product obtained by Comparative obtained 1 is shown in FIG. 7. A picture showing the back surface side of the molded product obtained by Comparative Example 3 is shown in FIG. 8.

TABLE 1

| | RESIN | | | | |
|---|---|---|---|---|---|
| | | TEMPERATURE | | | |
| | | OF THERMAL | BARREL | DIE TEMPERATURE | |
| | | DEFORMATION | TEMPERATURE | CAVITY DIE | CORE DIE |
| | TYPE | [° C.] | [° C.] | [° C.] | [° C.] |
| EXAMPLE 1 | AES | 78 | 240 | 95 | 95 |
| COMPARATIVE EXAMPLE 1 | | | | | |
| COMPARATIVE EXAMPLE 2 | | | | | |
| COMPARATIVE EXAMPLE 3 | | | | 60 | 60 |
| COMPARATIVE EXAMPLE 4 | | | | | |
| EXAMPLE 2 | PMMA | 100 | 250 | 105 | 105 |
| COMPARATIVE EXAMPLE 5 | | | | | |
| COMPARATIVE EXAMPLE 6 | | | | | |
| COMPARATIVE EXAMPLE 7 | | | | 80 | 80 |
| COMPARATIVE EXAMPLE 8 | | | | 60 | 60 |
| EXAMPLE 3 | | 78 | 250 | 100 | 100 |
| COMPARATIVE EXAMPLE 9 | | | | | |
| COMPARATIVE EXAMPLE 10 | | | | | |
| COMPARATIVE EXAMPLE 11 | | | | 70 | 70 |
| COMPARATIVE EXAMPLE 12 | | | | | |

| | MOLD | | | | WEIGHT |
|---|---|---|---|---|---|
| | CLAMPING | HOLDING PRESSURE | | COOLING | OF MOLDED |
| | FORCE | PRESSURE | TIME | TIME | PRODUCT |
| | [kN] | [MPa] | [SECONDS] | [SECONDS] | [g] |
| EXAMPLE 1 | 200 | — | — | 30 | 90 |
| COMPARATIVE EXAMPLE 1 | | — | — | 35 | 86 |
| COMPARATIVE EXAMPLE 2 | | — | — | 40 | 81 |
| COMPARATIVE EXAMPLE 3 | | — | — | 30 | 90 |
| COMPARATIVE EXAMPLE 4 | 1800 | 100 | 5 | 30 | 80 |
| EXAMPLE 2 | 200 | — | — | 30 | 103 |
| COMPARATIVE EXAMPLE 5 | | — | — | 35 | 98 |
| COMPARATIVE EXAMPLE 6 | | — | — | 40 | 93 |
| COMPARATIVE EXAMPLE 7 | | — | — | 30 | 103 |
| COMPARATIVE EXAMPLE 8 | 1800 | 100 | 5 | 30 | 94 |
| EXAMPLE 3 | 200 | — | — | 30 | 101 |
| COMPARATIVE EXAMPLE 9 | | — | — | 35 | 97 |
| COMPARATIVE EXAMPLE 10 | | — | — | 40 | 91 |
| COMPARATIVE EXAMPLE 11 | | — | — | 30 | 101 |
| COMPARATIVE EXAMPLE 12 | 1800 | 100 | 5 | 30 | 100 |

TABLE 2

| | STATE OF SINK | | | | | | | |
|---|---|---|---|---|---|---|---|---|
| | | RIB | RIB | RIB | RIB | SUBSTRATE | DEFORMATION | |
| | SUBSTRATE | (THICKNESS | (THICKNESS | (THICKNESS | (THICKNESS | BACK | | AFTER |
| | SURFACE | OF 1.0 MM) | OF 1.7 MM) | OF 2.4 MM) | OF 3.1 MM) | SURFACE | WARPAGE | REMOVAL |
| EXAMPLE 1 | ∘ | ∘ | ∘ | ∘ | ∘ | ∘ | ∘ | ∘ |
| COMPARATIVE | ∘ | ∘ | ∘ | ∘ | ∘ | Δ | ∘ | ∘ |
| EXAMPLE 1 | | | | | | | | |
| COMPARATIVE | ∘ | ∘ | ∘ | ∘ | ∘ | x | ∘ | ∘ |
| EXAMPLE 2 | | | | | | | | |
| COMPARATIVE | ∘ | x | x | x | x | ∘ | ∘ | ∘ |
| EXAMPLE 3 | | | | | | | | |
| COMPARATIVE | ∘ | x | x | x | x | ∘ | ∘ | ∘ |
| EXAMPLE 4 | | | | | | | | |
| EXAMPLE 2 | ∘ | ∘ | ∘ | ∘ | ∘ | ∘ | ∘ | ∘ |
| COMPARATIVE | ∘ | ∘ | ∘ | ∘ | ∘ | Δ | ∘ | ∘ |
| EXAMPLE 5 | | | | | | | | |
| COMPARATIVE | ∘ | ∘ | ∘ | ∘ | ∘ | x | ∘ | ∘ |
| EXAMPLE 6 | | | | | | | | |
| COMPARATIVE | ∘ | x | x | x | x | ∘ | ∘ | ∘ |
| EXAMPLE 7 | | | | | | | | |
| COMPARATIVE | ∘ | x | x | x | x | ∘ | ∘ | ∘ |
| EXAMPLE 8 | | | | | | | | |
| EXAMPLE 3 | ∘ | ∘ | ∘ | ∘ | ∘ | ∘ | ∘ | ∘ |
| COMPARATIVE | ∘ | ∘ | ∘ | ∘ | ∘ | Δ | ∘ | ∘ |
| EXAMPLE 9 | | | | | | | | |
| COMPARATIVE | ∘ | ∘ | ∘ | ∘ | ∘ | x | ∘ | ∘ |
| EXAMPLE 10 | | | | | | | | |
| COMPARATIVE | ∘ | x | x | x | x | ∘ | ∘ | ∘ |
| EXAMPLE 11 | | | | | | | | |
| COMPARATIVE | ∘ | x | x | x | x | ∘ | ∘ | ∘ |
| EXAMPLE 12 | | | | | | | | |

As shown in Tables 1 and 2 and FIGS. 5 and 6, in Examples 1 to 3 in which the temperature of the die is higher than the deformation temperature of the resin and the volume of the cavity is reduced due to volume contraction of the resin when cooling, a state where the resin is in close contact with the cavity surface during molding was maintained, and sink was prevented from being generated on the top surface or the back surface of the substrate and on the upper surface of each rib. Furthermore, warpage or deformation also was prevented.

As shown in Tables 1 and 2 and FIG. 7, in Comparative Examples 1, 2, 5, 6, 9, and 10 in which the filling amount of the resin is reduced, the volume of the resin due to volume contraction by the cooling process is smaller than the volume of the cavity when completely closing the die, and it was not possible to further reduce the volume of the cavity. For this reason, part of the resin is separated from the cavity surface in a mid-flow of cooling, and therefore sink is generated on the back surface side of the substrate. Additionally, the back surface side of the resin is separated from the core die in the cooling process, the space at the portion of the core die at which the ejector pin is provided serves as a ventilation pass, air enters from the outside of the die into the inside of the cavity through the ventilation pass, heat transfer from the resin to the core die is hindered, and therefore a length of cooling time was longer than that of Example.

As shown in Tables 1 and 2 and FIG. 8, in Comparative Examples 3, 7, and 11 in which the temperature of the die is lower than the deformation temperature of the resin, since a state where the resin is in close contact with the cavity surfaces of both the dies cannot be maintained at the time of injecting and filling of the resin, sink was generated on the upper surfaces of all of the ribs.

In Comparative Examples 4, 8, and 12 in which the mold clamping force was 1800 KN and a normal injection molding was carried out such that the volume of the cavity were not changed during molding, sink was generated on the upper surfaces of all of the ribs.

### DESCRIPTION OF REFERENCE NUMERALS

100 . . . injection molding die, 102 . . . cavity, 104 . . . PL, 110 . . . cavity die, 110a . . . cavity surface, 112 . . . recess, 120 . . . core die, 120a . . . cavity surface, 122 . . . projected portion, 124 . . . recess groove, 130 . . . die-thickness adjustment machine.

1. A method of manufacturing a molded product by injection molding using injection molding die including a pair of dies, comprising:
injecting and filling the resin in a molten state in a state where a temperature of the injection molding die is higher than a deformation temperature of resin to be injected and filled;
reducing a volume of a cavity due to volume contraction of the resin when cooling thereof; and
carrying out molding while maintaining a state where the resin is brought into close contact with both cavity surfaces of the pair of the dies.

2. The method of manufacturing a molded product according to claim 1, wherein temperatures of the pair of the dies are the same as each other.

3. The method of manufacturing a molded product according to claim 1, wherein
the injection molding die has a parting line having a pinched-off structure.
